(19) United States
(12) Patent Application Publication
(10) Pub. No.: US 2025/0244000 A1
(43) Pub. Date: Jul. 31, 2025

(54) Integrated Series-Connected Lamp String

(71) Applicant: Taizhou Tuxi Information Technology Co., Ltd, Taizhou (CN)

(72) Inventor: Xueli CHEN, Taizhou (CN)

(73) Assignee: Taizhou Tuxi Information Technology Co., Ltd, Taizhou (CN)

(21) Appl. No.: 18/426,269

(22) Filed: Jan. 29, 2024

(51) Int. Cl. F21V 23/02; F21V 23/06; F21Y 113/00

(52) U.S. Cl. CPC F21V 23/026; F21S 4/00; F21V 23/06; H01R 33/945; F21S 4/26; F21Y 2113/00

(57) ABSTRACT

An integrated series-connected lamp string comprises light sources and control boxes, and each light source is provided with a control box; the control box comprises a power inlet connector, a power transmission connector and an accommodating space, wherein a circuit board is arranged in the accommodating space, and the circuit board is provided with a transformer module and a control module; the power inlet connector is provided with a first high-voltage connection end, the power transmission connector is provided with a low-voltage connection end and a second high-voltage connection end, and the commercial power forms a high-voltage circuit and a low-voltage circuit through the transformer module; the high-voltage circuit is connected to the first high-voltage connection end of the next stage through the second high-voltage connection end, and the low-voltage circuit is connected to the light source through the low-voltage connection end.

### TECHNICAL FIELD

The present invention relates to the technical field of lighting equipment, in particular to an integrated series-connected lamp string.

### BACKGROUND

Most of the existing decorative lamp strings are powered by commercial power, and most of the light beads in the existing decorative lamp strings are LEDs, which are limited by the rated voltage of LEDs. When the decorative lamp strings are powered by commercial power, they need to be connected with a transformer to step down. When connecting lamp strings through transformers, the number of light beads that each transformer can connect is limited, which leads to the limited overall length of decorative lamp strings when power is supplied through a single transformer, which cannot meet the length requirements of lamp string decoration.

China patent with application number of 201420337125 discloses a transformer power supply, which comprises a plug with an input interface and a cover with a DC output interface. The input interface is connected with alternating current, which is converted into direct current through the transformer unit in the plug, and the direct current is provided to the lamp string through the direct current output interface. But the power supply cannot connect multiple bulbs in the lamp string at the same time, and the length of the lamp string is limited.

U.S. patent Ser. No. 14/199,689 discloses an LED lamp string, which includes a power supply, a switch, a controller and one or more strings of LEDs. The LED of the whole lamp string is adjusted by the controller, but this control method is easy to make the voltage of each bulb on the LED uneven and the brightness dim, thus affecting the overall effect of the lamp string.

Based on the above problems, the present invention provides a brand-new lamp string, which can ensure the brightness and voltage of each light bulb, and at the same time, the overall length of the lamp string will not be limited, which will not lead to overload because the lamp string is too long, and the entire lamp string can be extended to the required length.

### SUMMARY

The present invention provides an integrated series-connected lamp string, which includes a plurality of light sources and a plurality of control boxes, wherein a number of the plurality of light sources is the same as that of the plurality of control boxes, and each of the plurality of light sources has a corresponding control box; and
wherein, each of the plurality of control boxes comprises a power inlet connector and a power transmission connector, the power inlet connector and the power transmission connector is spaced by at least one accommodating space; and a circuit board is arranged in the accommodating space, and the circuit board is provided with a transformer module and a control module; and
wherein, the power inlet connector is provided with a first high-voltage connection end, the power transmission connector is provided with a low-voltage connection end and a second high-voltage connection end; a commercial power supply is electrically connected with the transformer module through the first high-voltage connection end, and a high-voltage circuit and a low-voltage circuit are formed through the transformer module; and
wherein the high-voltage circuit is connected to the first high-voltage connection end of a next control box through the second high-voltage connection end, and the low-voltage circuit is connected to the light source through the low-voltage connection end; and
wherein the high-voltage circuit is arranged far away from the light source, and the control module controls the work of the plurality of light sources.

The present invention also provides an integrated series-connected lamp string, which includes a plurality of lamps and a plurality of control boxes, wherein a number of the plurality of lamps is the same as that of the plurality of control boxes, and each of the plurality of lamps has a corresponding control box; and
wherein at least two high-voltage wires and at least one light source is arranged in the lamp, wherein the light source is connected with at least three low-voltage wires, and the at least two high-voltage wires are arranged far away from the light source and are not connected with the light source; and
wherein, each of the plurality of control boxes comprises a power inlet connector and a power transmission connector, wherein the power inlet connector is provided with at least two strong electricity slots, and the power transmission connector is provided with at least three weak electricity slots and at least two strong electricity slots; and the strong electricity slots and the weak electricity slots are respectively and correspondingly connected with the high-voltage wire and the low-voltage wire for conducting and transmitting low-voltage electricity and high-voltage electricity; and
wherein, the control box comprises a transformer module and a control module, the power inlet connector is provided with a first high-voltage connection end, the power transmission connector is provided with a low-voltage connection end and a second high-voltage connection end; a commercial power supply is electrically connected with the transformer module through the first high-voltage connection end, and a high-voltage circuit and a low-voltage circuit are formed through the transformer module; and
wherein, the high-voltage circuit is connected to the high-voltage wire through the second high-voltage connection end, the high-voltage wire is connected to the first high-voltage connection end of a next control box, the low-voltage circuit is connected to the low-voltage wire through the low-voltage connection end to supply power to the lamps, and the control module controls the work of the plurality of lamps.

The present invention also provides an integrated series-connected lamp string, which includes a plurality of lamp string modules, wherein any one of the pluralities of lamp string modules comprises a light source and a control box, and the control box correspondingly controls the light source; and
wherein, the control box comprises a power inlet connector and a power transmission connector, and the power inlet connector and the power transmission connector are spaced by at least one accommodating space; a circuit board is arranged in the accommodating space, and the circuit board is provided with a transformer module and a control module; and
wherein, the power inlet connector is provided with a first high-voltage connection end, the power transmission connector is provided with a low-voltage connection end and a second high-voltage connection end; and a commercial power supply is electrically connected with the transformer module through the first high-voltage connection end, and a high-voltage circuit and a low-voltage circuit are formed through the transformer module; and
wherein the low-voltage circuit is connected to the light source through the low-voltage connection end, and the control module controls the work of the light source; and the plurality of lamp string modules are electrically connected in series, and the high-voltage circuit is connected to a first high-voltage connection end of a next lamp string module through the second high-voltage connection end.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of an integrated series-connected lamp string in the application of the present invention;

FIG. 2 is an exploded view of the integrated series-connected lamp string in the application of the present invention;

FIG. 3 is a schematic diagram of the control box in the application of the present invention;

FIG. 4 is a schematic diagram of the control box in the application of the present invention;

FIG. 5 is a schematic diagram of the control box in the application of the present invention;

FIG. 6 is a schematic diagram of the control box in the application of the present invention;

FIG. 7 is a schematic view of the lock cover in the application of the present invention;

FIG. 8 is a schematic diagram of the power inlet connector in the application of the present invention;

FIG. 9 is a schematic diagram of the power transmission connector in the application of the present invention;

FIG. 10 is a schematic diagram of the lamp in the application of the present invention;

FIG. 11 is a schematic diagram of the internal structure of the lamp in the application of the present invention;

FIG. 12 is a schematic diagram of the first connector in the application of the present invention;

FIG. 13 is a schematic diagram of the second connector in the application of the present invention;

FIG. 14 is a schematic diagram of a lamp string module in the application of the present invention:

FIG. 15 is a schematic diagram of the circuit in the application of the present invention.

In the picture:
Integrated series-connected lamp string (1000); Plug (1001); Wire (1002); Lamp (2000); Light source (2100); High-voltage wire (2150); low-voltage wire (2160); First connector (2200); Second connector (2300); Weak electricity ferrule (2310); Strong electricity ferrule (2320); Partition board (2330); Lock cover (2400); Round hole (2410); Lamp string module (3000); Control box (4000); Shell (4100); Connecting block (4101); Through hole (4102); Power inlet connector (4110); First high-voltage connection end (4111); Power transmission connector (4120); Second high-voltage connection end (4121); Low-voltage connection end (4122); Fixing groove (4130); Fixing buckle (4131); Weak electricity slot (4140); Strong electricity slot (4150); Groove (4160); Cover (4200); Accommodating space (4300); Circuit board (4310); Transformer module (4311); Control module (4312).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on.” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of the application of the present invention, in order to prevent the transformer from being overloaded due to the excessively long length of the lamp string, the user can safely extend the whole lamp string until the length desired by the user. The present invention provides a brand-new integrated series-connected lamp string.

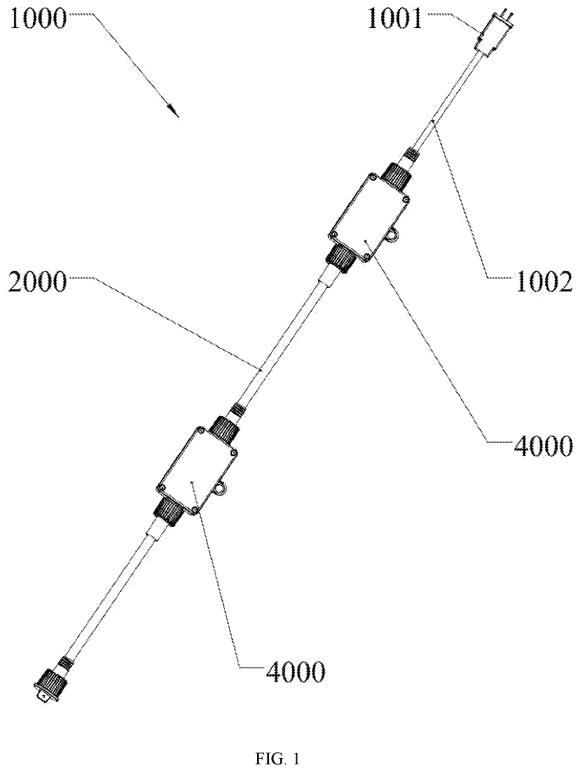

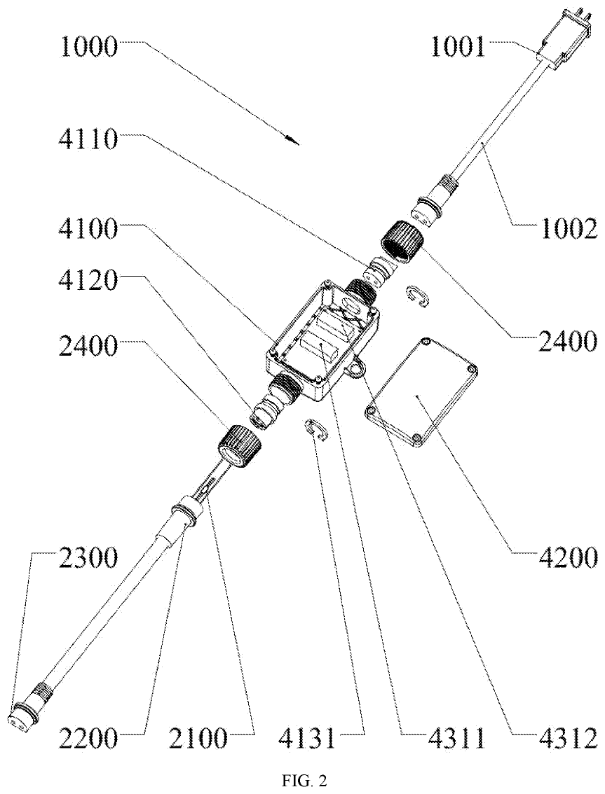

Referring to FIG. 1 and FIG. 2, an integrated series-connected lamp string 1000 includes a plurality of light sources 2100 and control boxes 4000, wherein the number of light sources 2100 is the same as that of the plurality of control boxes 4000, and each control box 4000 is designated to control a plurality of light sources 2100.

Referring to FIGS. 1 to 3, the control box 4000 includes a shell 4100 and a cover 4200, wherein the shell 4100 has a rectangular structure with four threaded holes, and the cover 4200 is detachably connected with the shell 4100 through bolts.

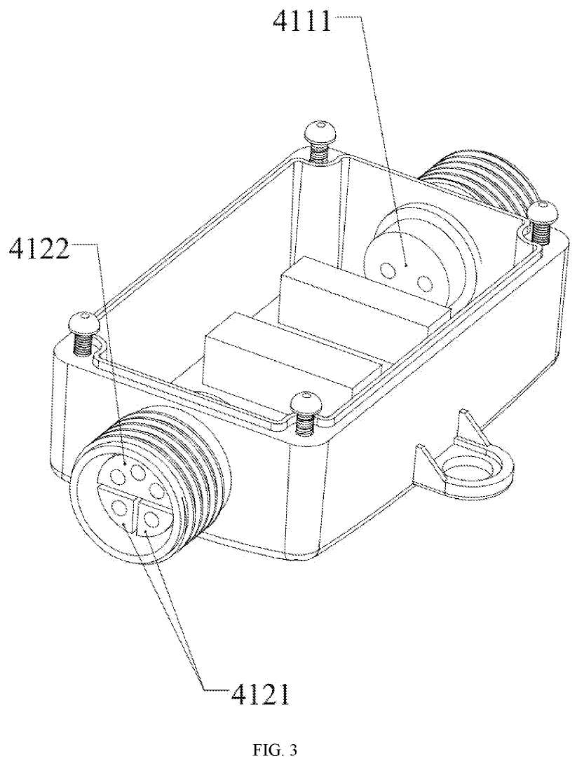

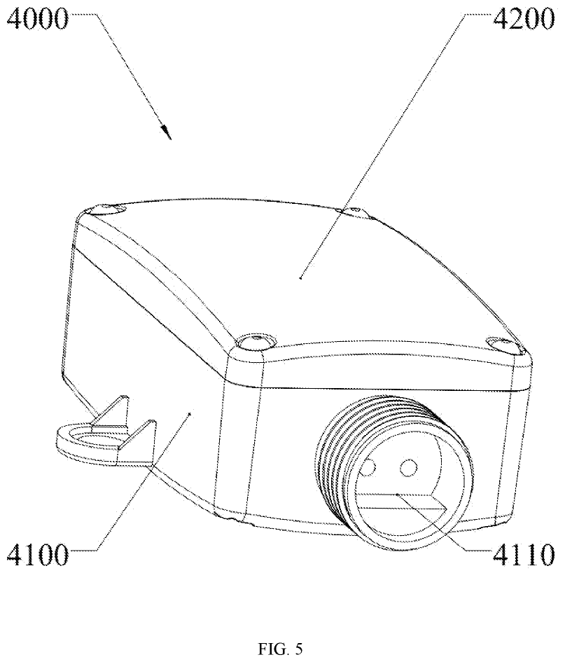

Referring to FIG. 3 to FIG. 5, each control box 4000 includes a power inlet connector 4110 and a power transmission connector 4120. An accommodating space 4300 is arranged between the power inlet connector 4110 and the power transmission connector 4120, and a circuit board 4310 is connected and fixed in the accommodating space 4300. A transformer module 4311 and a control module 4312 are fixed on the circuit board 4310, and the transformer module 4311 and the control module 4312 are electrically connected to the circuit board 4310 and fixed on the circuit board 4310 by welding.

In other embodiments (not shown in the figure), the control box 4000 can be integrated by snap connection, or key connection, pin connection, or hook and loop connection, or is integrated by an integrated structure, etc. Meanwhile, the fixing method of the transformer module 4311 and the control module 4312 can also be adhesive connection, or other connecting and fixing methods such as hot melt adhesive.

Further, the transformer module 4311 is used to transform high-voltage electricity into low-voltage electricity for the light source 2100, and the control module 4312 is used to control the light source 2100 to work. Meanwhile, the bottom of the shell 4100 is provided with connecting blocks 4101, which fix four corners of the circuit board 4310, so that the circuit board 4310 can be detachably connected and fixed at the bottom of the shell 4100.

The transformer module 4311 includes a voltage regulating component and a protection component. The voltage regulating component divides and reduces the voltage of the commercial power supply to form a high-voltage circuit and a low-voltage circuit respectively. The protection component includes an overload monitoring module, and the overload detection module monitors and protects the transformer module to prevent the transformer module from being damaged due to overload.

Further, there are various circuits on the circuit board 4310, and the control module 4312 includes a single chip microcomputer, which is connected with the transformer module 4311, and the transformer module 4311 converts high-voltage electricity into low-voltage electricity, thereby supplying power to the control module 4312. In this embodiment, the control module 4312 controls the light source 2100 through circuit signals.

In some embodiments (not shown in the figure), the circuits on the circuit board 4310 may include well-known circuits for performing functions, including but not limited to an antenna system, an RF transceiver, one or more amplifiers, a tuner, one or more oscillators, a digital signal processor, a CODEC chipset, a subscriber identity module (SIM) card, a memory, and the like.

In other embodiments (not shown in the figure), the control module 4312 can also control the operation of the light source 2100 through a network system circuit, which is used to receive and send signals, including but not limited to RF, also known as electromagnetic signals. The network system circuit converts electrical signals into electromagnetic signals and communicates with communication networks and other communication devices through the electromagnetic signals. Network system circuits may include well-known circuits for performing these functions, including but not limited to an antenna system, a RF transceiver, one or more amplifiers, a tuner, one or more oscillators, a digital signal processor, a CODEC chipset, a subscriber identity module (SIM) card, a memory, and the like. The network system circuit can communicate with a network, such as the Internet, also known as the World Wide Web (WWW), an intranet and/or a wireless network, such as a cellular telephone network, a wireless local area network (LAN) and/or a metropolitan area network (MAN), and other devices that communicate wirelessly.

Further, the control box 4000 also includes a communication module, which includes an antenna component, wherein the communication module wirelessly communicates with the user through the antenna component and receives control instructions sent by the user.

Specifically, each control box 4000 has a specific code, and the control boxes 4000 can communicate with each other through the communication module. When one of the control boxes 4000 communicates wirelessly with the user, the control box 4000 will generate a set of corresponding control signals according to the control instructions sent by the user and send the control signals to other corresponding control boxes 4000 respectively, so as to control all the light sources 2100.

These control box 4000 generates dimming instructions according to the received control signals and control the work of the light sources according to the dimming instructions, wherein each control box 4000 communicates with the corresponding light source 2100 according to the DMX512 control protocol, thereby controlling the switch or color change of the light source 2100.

DMX512 protocol is a data dimming protocol proposed by the United States Institute for Theatre Technology (USITT), which provides a protocol standard for communication between lighting controllers and lighting equipment. Because it was proposed in 1990, the full name of the protocol is USITTDMX512(1990). The protocol provides a good standard for controlling lighting equipment with digital signals.

In other embodiments (not shown in the figure), the control protocol on which the light source 2100 is based can also be other types of lighting control protocols, such as KNX control protocol, Z-Wave control protocol, Zigbee control protocol, Dali control protocol or supplier-defined control protocol. No matter what lighting control protocol, as long as the light source 2100 can make corresponding function switching.

Further, the control signal is a series-connected data signal consisting of an address code, a data code and a synchronization code. The address code marks each control box 4000, that is, the address code corresponding to each control box 4000 is the same, and the address code is the number set when the product leaves the factory. The control module 4312 controls the corresponding control box 4000 by adjusting and controlling the address code to realize the adjustment and control of the light source 2100.

In other embodiments (not shown in the figure), the communication means can use any of a variety of communication standards, protocols and technologies, including, but are not limited to, global system for mobile communications (GSM), enhanced data GSM environment (EDGE), high-speed downlink packet access (HSDPA), wideband code division multiple access (W-CDMA), code division multiple access (CDMA), time division multiple access (TDMA), BLUETOOTH®, wireless fidelity (Wi-Fi) (for example, IEEE802.11a, IEEE802.11b, IEEE802.11g or IEEE802.11n), Voice over Internet Protocol (VoIP), Wi-MAX, email protocol (e.g., Internet Message Access Protocol (IMAP) and/or post office protocol (POP)), instant messaging (e.g., Extensible Messaging and Presence Protocol (XMPP), Session Initiation Protocol for Instant Messaging and Presence Leveraging Extensions (SIMPLE) or Instant Messaging Presence Services (IMPS), or Short Message Service (SMS), or any other suitable communication protocol, including those developed and not yet completed since the date of submission of this document.

Further, the control module 4312 responds to the user's control device and controls the light source 2100 to be turned on or off by receiving the signal sent by the control device, or changes the color emitted by the light source 2100. In this embodiment, the types of control devices are not limited.

In other embodiments (not shown in the figure), the control mode may include physical buttons, such as rocker, dial, slide switch, touch switch, toggle switch and joystick, click wheel, etc. In some alternative embodiments (not shown in the figure), the control mode can be coupled to any of the following (or decoupled): keyboard, infrared port, USB port and pointing device, such as mouse. In some embodiments (not shown in the figure), the control mode can also be electronic devices, such as touch screens, computer devices and other control system devices.

In some embodiments (not shown in the figure), the control mode can be controlled by mobile devices, including but not limited to mobile phones, such as Apple's iPhone®, other portable electronic devices, such as Apple's iPod Touches®, Apple's iPad®, and Google-based Android mobile device operating system, and any other portable electronic devices, including software, firmware, hardware or combinations thereof, which can at least receive signals, decode (if necessary), and exchange information with the server to verify information. Typical components of a mobile device may include, but not limited to, permanent memory such as flash ROM, random access memory such as SRAM, camera, battery, LCD driver, display, cellular antenna, speaker. Bluetooth® circuit and WIFI circuit, wherein the permanent memory may contain programs, applications and/or operating systems for mobile devices. The mobile device may be a key fob. Key fob, which can be a security token, is a small hardware device with built-in authentication mechanism. It is used to manage and protect access to network services, data, provide access, and communicate with devices.

In some embodiments, the operating system of the mobile device (e.g., Darwin, RTXC, LINUX, UNIX, OSX, WINDOWS, or an embedded operating system such as VxWorks) includes functions for controlling and managing general system tasks (e.g., memory management, storage device control, power management, etc.) and facilitating communication between various hardware and software components.

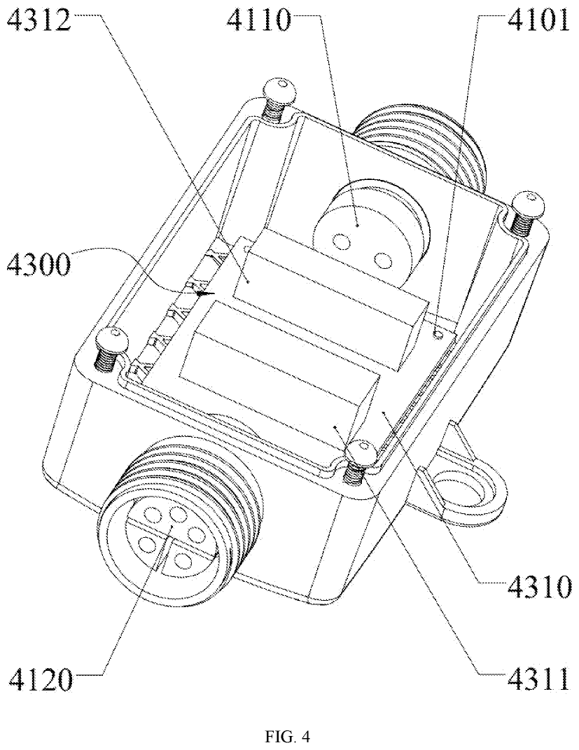

Referring to FIGS. 4 to 9, further, the power inlet connector 4110 and the power transmission connector 4120 are arranged at both ends of the shell 4100. The power inlet connector 4110 is provided with a first high-voltage connection end 4111, and the power transmission connector 4120 is provided with a low-voltage connection end 4122 and a second high-voltage connection end 4121.

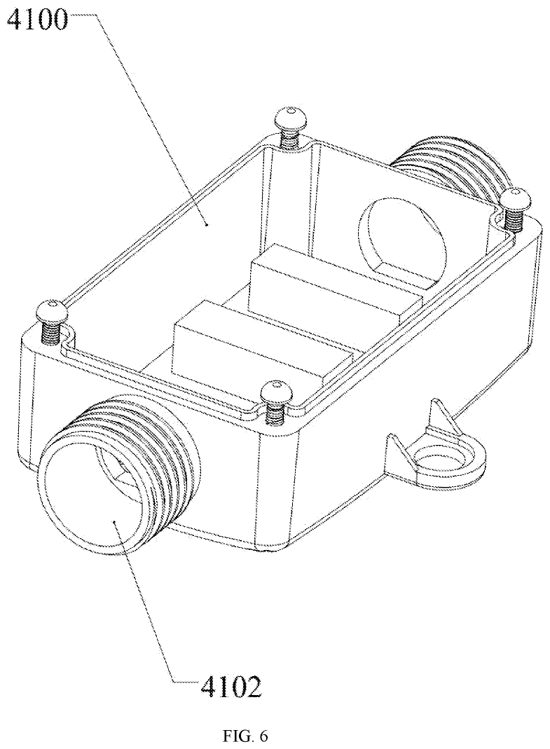

Referring to FIG. 6, two sides of the shell 4100 are provided with through holes 4102, wherein the through holes 4102 communicate with the accommodating space 4300, and the power inlet connector 4110 and the power transmission connector 4120 are inserted into the shell 4100 through the through holes 4102.

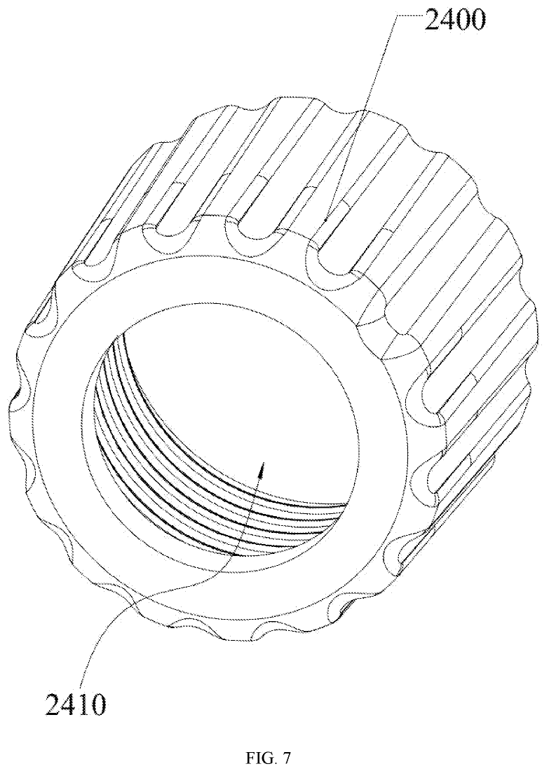

Further, the power inlet connector 4110 of the first control box 4000 is connected with a plug 1001, and the plug 1001 is connected with a wire 1002. One end of the wire 1002 is connected with the plug 1001, and the other end is connected with the power inlet connector 4110. At the same time, the periphery of the through hole 4102 is provided with threads, and a lock cover 2400 (see FIG. 7) is connected through the threads. The center of the lock cover 2400 is provided with a round hole 2410 for the connector to pass through, wherein the lock cover 2400 plays a fixing role through threaded connection.

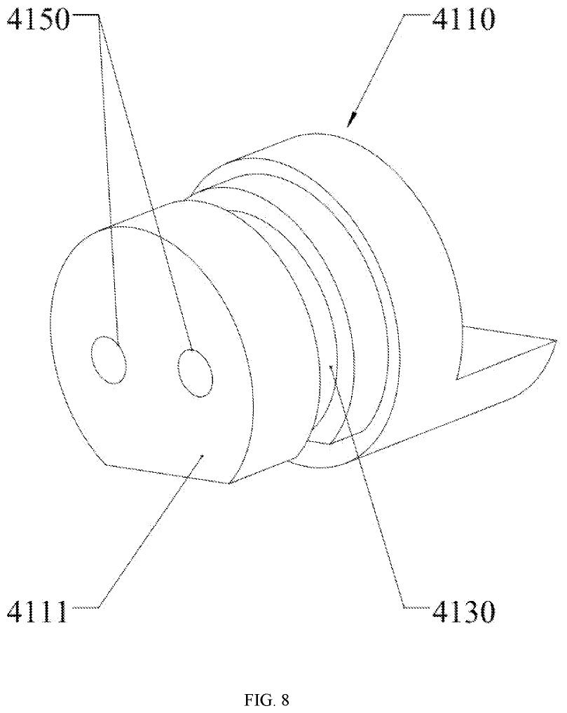

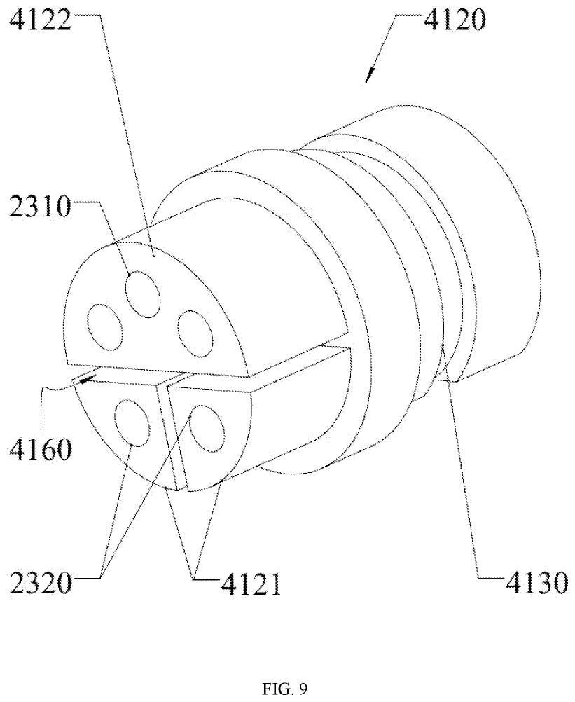

Referring to FIGS. 8 and 9, both the power inlet connector 4110 and the power transmission connector 4120 are provided with fixing grooves 4130. When the power inlet connector 4110 and the power transmission connector 4120 are inserted into the shell 4100, the fixing grooves 4130 are located in the shell 4100. By fastening a fixing buckle 4131 on the fixing grooves 4130, the power inlet connector 4110 and the power transmission connector 4120 are connected and fixed in the through hole 4102 of the shell 4100, and at the same time, the fixing buckle 4131 contacts the inner wall of the shell 4100.

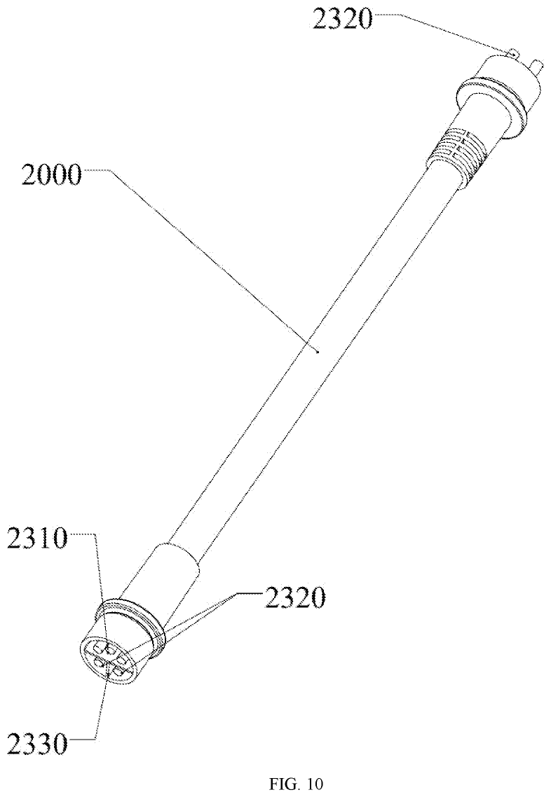

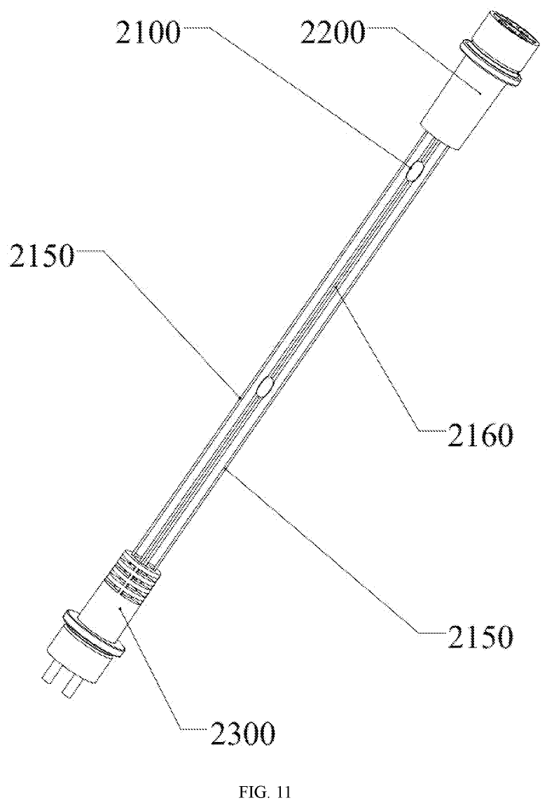

Referring to FIG. 10 and FIG. 11, a light source 2100 is arranged in a lamp 2000. The lamp 2000 has a hollow structure with at least two high-voltage wires 2150 and at least three low-voltage wires 2160. The light source 2100 is arranged on the low-voltage wires 2160, and the high-voltage wires are arranged on both sides of the low-voltage wires at intervals. In this embodiment, the number of high-voltage wires 2150 is two, corresponding to the positive and negative poles of commercial power, and the number of low-voltage wires 2160 is three.

In other embodiments (not shown in the figure), the number of high-voltage wires 2150 and low-voltage wires 2160 can be any other quantitative characteristics, as long as sufficient power can be supplied to the lamp 2000.

In this embodiment, the light source 2100 uses a point-controlled RGB lamp, which is powered by a transformer module, and the light-emitting form of the point-controlled RGB is controlled by a control module 4312 to obtain different light-emitting effects.

In other embodiments, the light source 2100 can also be a light bulb, or an LED lamp, or a lamp strip, or a line lamp and other components that can emit light.

Two ends of the lamp 2000 are respectively provided with a first connector 2200 and a second connector 2300. The first connector 2200 is connected with the power transmission connector 4120, and the second connector 2300 is connected with the power inlet connector 4110 of the control box 4000 of the next stage.

Further, as shown in FIGS. 8 and 9, both the power inlet connector 4110 and the power transmission connector 4120 are provided with slots, including a weak electricity slot 4140 and a strong electricity slot 4150, wherein the weak electricity slot 4140 is used for conducting low-voltage electricity and the strong electricity slot 4150 is used for conducting high-voltage electricity. The power inlet connector 4110 is only provided with a strong electricity slot 4150, and the power transmission connector 4120 is provided with a weak electricity slot 4140 and a strong electricity slot 4150.

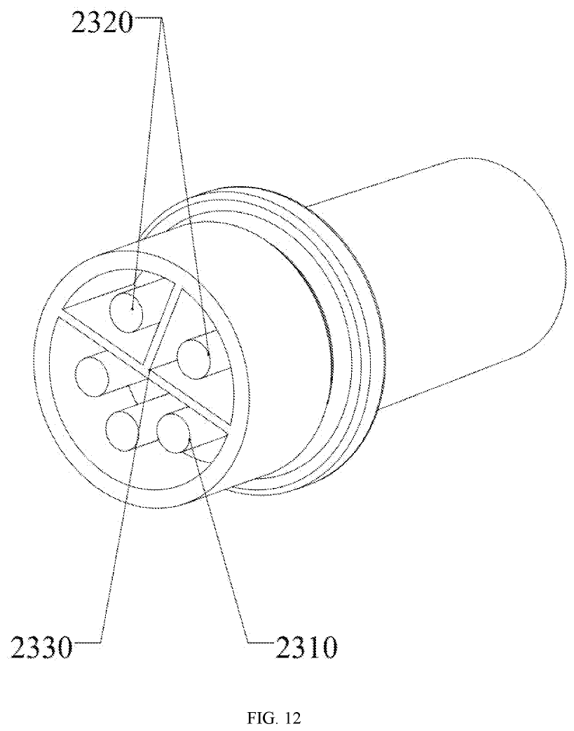

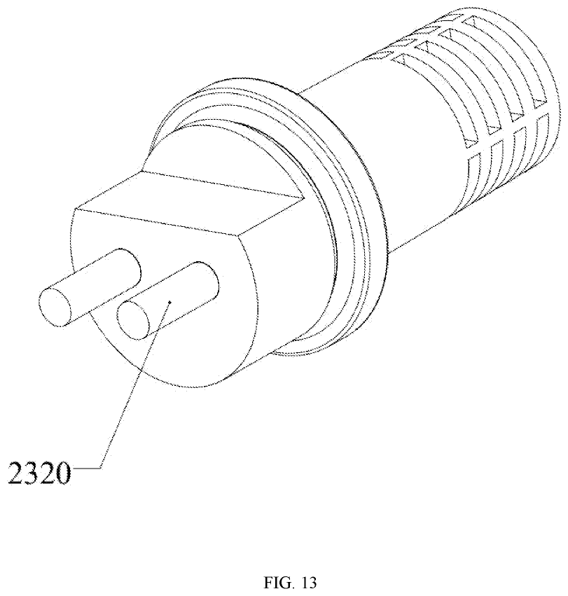

Further, as shown in FIG. 12 and FIG. 13, ferrules are arranged in the connection joint, and the ferrules have an outward protruding structure. The ferrules include a weak electricity ferrule 2310 and a strong electricity ferrule 2320, and the weak electricity ferrule 2310 is adapted to a weak electricity slot 4140, and the strong electricity ferrule 2320 is adapted to a strong electricity slot 4150. The first connector 2200 is provided with a weak electricity ferrule 2310 and a strong electricity ferrule 2320, and the second connector 2300 is provided with only the strong electricity ferrule 2320.

Further, as shown in FIG. 9 to FIG. 13, the power transmission connector 4120 is provided with a groove 4160 which is T-shaped to separate the weak electricity slot 4140 from the strong electricity slot 4150, and the first connector 2200 is provided with a partition board 2330 which is also T-shaped and separates the weak electricity ferrule 2310 from the strong electricity ferrule 2310. Meanwhile, the number of the high-voltage ferrules 2320 and the high-voltage slots 4150 is two, and the partition board 2330 and the groove 4160 also separate the high-voltage ferrules 2320 and the high-voltage slots 4150 respectively. The shapes of the partition board 2330 and the groove 4160 are matched. When the first connector 2200 and the power transmission connector 4120 are connected and conducted, the partition board 2330 can be embedded in the groove 4160 and contact with the inner wall of the groove 4160 to form a fixation. With this arrangement, when the first connector 2200 is connected with the power transmission connector 4120, it can only be plugged in one direction, thus ensuring that the plugging direction is always correct and preventing the phenomenon of wrong plugging.

In some embodiments (not shown in the figure), the shapes of the partition board 2330 and the groove 4160 are not limited to the above structural shapes, and the shapes can also be “H” shapes, or “L” shapes, or trapezoidal shapes, or other characters and geometric shapes, as long as it can ensure that there is no wrong insertion.

Specifically, as shown in FIGS. 1 to 13, each lamp 2000 is equipped with a new control box 4000. When the plug 1001 is plugged into the power supply and connected to the commercial power, the high-voltage current will pass through the wire 1002, then flow through the first high-voltage connection end 4111 of the power inlet connector 4110, and finally be conducted to the first control box 4000. The voltage regulating component of the transformer module 4311 in the control box 4000 will divide and reduce the voltage of the commercial power supply, thus forming a high-voltage circuit and a low-voltage circuit, wherein the low-voltage circuit supplies power to the control module 4312 and the lamp 2000, and the low-voltage circuit transmits low-voltage electricity to the low-voltage conductor 2160 of the lamp 2000 through the low-voltage connection end 4122 of the power transmission connector 4120, thus realizing the light emission of the light source 2100.

The high-voltage circuit is connected to the lamp 2000 through the second high-voltage connection end 4121, and then transmitted to the first high-voltage connection end 4111 of the next control box 4000 through the high-voltage wire 2150 in the lamp 2000, so as to supply power to the next control box 4000, and this cycle is repeated to form the extension of the integrated series-connected lamp string 1000.

When the power is turned on, the user can control the control box 4000 through the control device, so as to realize the work control of the lamp 2000, and the user can change the switch of the light source 2100 and the color of the light source 2100. Each control box 4000 is provided with a control module 4312 and a communication module, each control module 4312 controls each corresponding control box 4000, and the communication module not only communicates with the user's control equipment, but also communicates with the communication modules in the adjacent control boxes 4000. When a user sends a control command to the communication module in any one of the control boxes 4000, the communication module will receive the control command and generate a control signal, which will be transmitted to the control module 4312 in the control box 4000, and the control module 4312 will control the switch or color change of the light source 2100; and at the same time, the control signal will be transmitted to the communication module in the adjacent control box 4000, so as to control the light source 2100 to achieve the same operation.

Step-by-step transmission and control are continuously performed, until all control boxes 4000 execute the same control instruction. The advantage of this arrangement is that when the lamp string is too long, the control box 4000, which is far away from the control equipment, may not receive the control signal. By gradually transmitting the control signal through the communication module, remote signal control can be realized, making the whole lamp string more convenient to control.

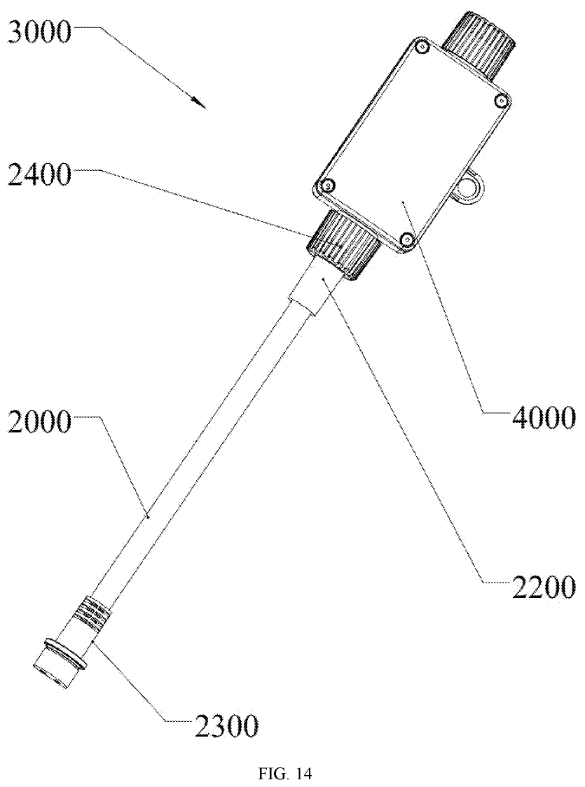

As another preferred embodiment of the application of the present invention, the integrated series-connected lamp string 1000 is composed of a plurality of lamp string modules 3000. As shown in FIG. 14, in this embodiment, the lamp 2000 and the control box 4000 are integrated to form the lamp string module 3000. The lamp string module 3000 also has the structure of the above embodiment. The integrated series-connected lamp string 1000 is composed of a plurality of lamp string modules 3000 connected in series.

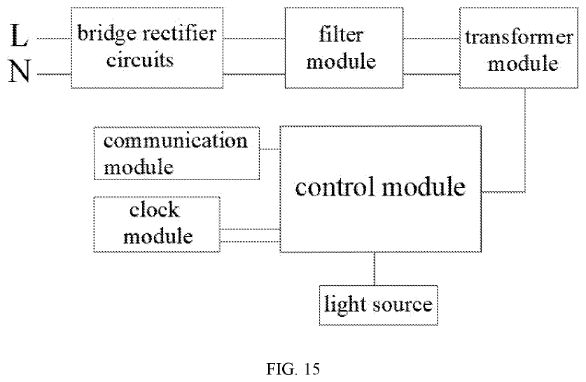

Referring to FIG. 15, the integrated series-connected lamp string 1000 includes a bridge rectifier circuit and a filter module. The bridge rectifier circuit is the most commonly used circuit to rectify by using the unidirectional conductivity of a diode, which is often used to convert alternating current into direct current. The filter module is one of the core modules of signal processing, and its function is to remove noise and unnecessary frequency components in the signal and keep the needed signal components in order to extract useful information better.

The voltage flows through the bridge rectifier circuit and the filter module successively, in which the transformer module 4311 is connected behind the filter module. In this embodiment, the transformer module 4311 is a high-frequency electronic transformer, and the transformer module 4311 converts the voltage into a low-voltage circuit and supplies power to the control module 4312.

In other embodiments (not shown in the figure), the transformer module 4311 can also be a DC-DC converter, a network transformer, or a high-voltage power module.

Further, the control module 4312 is a single chip microcomputer, and is equipped with a clock module and a communication module. The clock module is used to provide a stable counting pulse for timing. The light source 2100 is directly connected to the control module 4312, which transmits voltage for the light source 2100.

In the above-mentioned embodiment, in the attached drawings of the embodiment, the length of the lamp string is greatly shortened for the convenience of showing the product structure. In fact, the length of the lamp string can be as long as several meters, and users can freely choose the length and shape of the lamps to assemble different styles of lamp strings.

In the broad sense of the application of the present invention, the design of integrated series-connected lamp string can be applied to many fields, including but not limited to: lighting industry, which can be used to produce various types of lamps, such as indoor lighting, outdoor lighting, decorative lighting, etc.; or in holiday decoration, this design is especially suitable for holiday decoration, such as Christmas, New Year, Mid-Autumn Festival, etc., various lighting effects may be created since each lamp can be controlled; or in the advertising industry, this design can be used to make various lighting advertisements, such as neon advertising, LED advertising, etc.; or in stage design, this design can provide flexible lighting solutions to create various stage effects; or in architectural lighting, this design can provide efficient and safe lighting solutions, especially in the case of a large number of lamps; or in public facilities, such as parks, squares, pedestrian streets and other places, this design can provide lasting and stable lighting.

To sum up, the design of the integrated series-connected lamp string provided by the application of the present invention has the following advantages: safety, high-voltage wires, low-voltage wires and light sources are arranged inside the lamp, which can effectively prevent current leakage and improve the safety of use; being easy to maintain, the design of the control box makes the circuit board, transformer module and control module easy to access and maintain; energy saving, electric energy can be effectively saved by controlling the light source to work through the transformer module and the control module; being convenient to connect, both ends of the control box are respectively provided with power inlet connectors and power transmission connectors, which makes the connection between lamp strings simple and convenient.

The terms “comprising.” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. An integrated series-connected lamp string, comprising a plurality of light sources and a plurality of control boxes, wherein a number of the plurality of light sources is the same as that of the plurality of control boxes, and each of the plurality of light sources has a corresponding control box; and
wherein, each of the plurality of control boxes comprises a power inlet connector and a power transmission connector, said power inlet connector and said power transmission connector is spaced by at least one accommodating space; and a circuit board is arranged in said accommodating space, and said circuit board is provided with a transformer module and a control module; and
wherein, said power inlet connector is provided with a first high-voltage connection end, said power transmission connector is provided with a low-voltage connection end and a second high-voltage connection end; a commercial power supply is electrically connected with said transformer module through said first high-voltage connection end, and a high-voltage circuit and a low-voltage circuit are formed through said transformer module; and
wherein said high-voltage circuit is connected to said first high-voltage connection end of a next control box through said second high-voltage connection end, and said low-voltage circuit is connected to said light source through said low-voltage connection end; and
wherein said high-voltage circuit is arranged far away from said light source and said control module controls the work of the plurality of light sources.

2. The integrated series-connected lamp string according to claim 1, wherein said control boxes further comprises a communication module, and said communication module comprises an antenna component, and wirelessly communicates with a user through said antenna component and receives control instructions sent by said user.

3. The integrated series-connected lamp string according to claim 2, wherein said transformer module comprises a voltage regulating component and a protection component, wherein said voltage regulating component divides and reduces a voltage of said commercial power supply to form said high-voltage circuit and said low-voltage circuit respectively; and said protection component comprises an overload monitoring module, and said overload monitoring module monitors a running state of said transformer module and performs protection.

4. The integrated series-connected lamp string according to claim 3, wherein each of the plurality of control boxes has a specific code, and the plurality of control boxes can communicate with each other through said communication module; and
wherein, any one of the pluralities of control boxes can wirelessly communicate with a user, generate a group of control signals according to said control instructions sent by said user, and send said control signals to other corresponding control boxes respectively.

5. The integrated series-connected lamp string according to claim 4, wherein said control box generates a dimming command according to received said control signals and controls the work of said light sources according to said dimming command, wherein each of the plurality of control boxes communicates with corresponding said light sources according to a DMX512 control protocol.

6. The integrated series-connected lamp string according to claim 5, wherein said control signals is a series-connected data signal consisting of an address code, a data code and a synchronization code, wherein said address code marks any one of the pluralities of control boxes and said control module in said control box regulates said address code.

7. The integrated series-connected lamp string according to claim 6, wherein when said communication module receives said control signals, said communication module sends a control signal to adjacent said communication module to control said light source to work, thus realizing a step-by-step control of said lamp string.

8. An integrated series-connected lamp string, comprising a plurality of lamps and a plurality of control boxes, wherein a number of the plurality of lamps is the same as that of the plurality of control boxes, and each of the plurality of lamps has a corresponding control box; and
wherein at least two high-voltage wires and at least one light source is arranged in said lamp, wherein said light source is connected with at least three low-voltage wires, and the at least two high-voltage wires are arranged far away from said light source and are not connected with said light source; and
wherein, each of the plurality of control boxes comprises a power inlet connector and a power transmission connector, wherein said power inlet connector is provided with at least two strong electricity slots, and said power transmission connector is provided with at least three weak electricity slots and at least two strong electricity slots; and said strong electricity slots and said weak electricity slots are respectively and correspondingly connected with said high-voltage wire and said low-voltage wire for conducting and transmitting low-voltage electricity and high-voltage electricity; and
wherein, said control box comprises a transformer module and a control module, said power inlet connector is provided with a first high-voltage connection end, said power transmission connector is provided with a low-voltage connection end and a second high-voltage connection end; a commercial power supply is electrically connected with said transformer module through said first high-voltage connection end, and a high-voltage circuit and a low-voltage circuit are formed through said transformer module; and
wherein, said high-voltage circuit is connected to said high-voltage wire through said second high-voltage connection end, said high-voltage wire is connected to said first high-voltage connection end of a next control box, said low-voltage circuit is connected to said low-voltage wire through said low-voltage connection end to supply power to said lamps, and said control module controls the work of the plurality of lamps.

9. The integrated series-connected lamp string according to claim 8, wherein an inside of said lamps is hollow, wherein said lamps contains two high-voltage wires, and said two high-voltage wires are arranged on both sides of the at least three low-voltage wires at intervals.

10. The integrated series-connected lamp string according to claim 9, wherein said control boxes comprises a shell, and said shell is provided with a through hole, the interior of said shell has an accommodating space, wherein said through hole is communicated with said accommodating space, and at least a part of said power inlet connector and said power transmission connector are inserted into said shell through said through hole.

11. The integrated series-connected lamp string according to claim 10, wherein both said power inlet connector and said power transmission connector are provided with fixing grooves, wherein when said power inlet connector or said power transmission connector is fixed in said through hole, said fixing grooves are located inside said shell, and said fixing grooves are connected with fixing buckles which are in contact with an inner wall of said shell.

12. The integrated series-connected lamp string according to claim 11, wherein a periphery of said through hole is connected with a lock cover, which is connected with said through hole through screw rotation; and a center of said lock cover is provided with a round hole through which said lamp passes, wherein when said lamp is connected with said power inlet connector or said power transmission connector, said lock cover plays a fastening role.

13. The integrated series-connected lamp string according to claim 12, wherein said light source has various adjustable colors, and said light source is one of a point-controlled RGB lamp, a lamp bulb, a LED lamp, a lamp strip and a line lamp.

14. The integrated series-connected lamp string according to claim 13, wherein two ends of said lamp are respectively provided with a first connector and a second connector and said first connector is connected and conducted with said power transmission connector and said second connector is connected and conducted with said power inlet connector at a next stage.

15. The integrated series-connected lamp string according to claim 14, wherein said first connector is provided with a weak electricity ferrule and a strong electricity ferrule and said second connector is only provided with a strong electricity ferrule and said weak electricity ferrule and said strong electricity ferrule extend along a length direction of said lamp and are respectively adapted to said weak electricity slots and said strong electricity slots.

16. The integrated series-connected lamp string according to claim 15, wherein said first connector is provided with a partition board, and said power transmission connector is provided with a groove matched with said partition board, wherein said partition board separates said weak electricity ferrule from said strong electricity ferrule, and said groove separates said weak electricity slot from said strong electricity slot, and said partition board and said groove are T-shaped and can be embedded.

17. An integrated series-connected lamp string, comprising a plurality of lamp string modules, wherein any one of the pluralities of lamp string modules comprises a light source and a control box, and said control box controls said light source correspondingly; and
wherein, said control box comprises a power inlet connector and a power transmission connector, and said power inlet connector and said power transmission connector are spaced by at least one accommodating space, a circuit board is arranged in said accommodating space, and said circuit board is provided with a transformer module and a control module; and
wherein, said power inlet connector is provided with a first high-voltage connection end, said power transmission connector is provided with a low-voltage connection end and a second high-voltage connection end; and a commercial power supply is electrically connected with said transformer module through said first high-voltage connection end, and a high-voltage circuit and a low-voltage circuit are formed through said transformer module; and
wherein said low-voltage circuit is connected to said light source through said low-voltage connection end and said control module controls the work of said light source; and the plurality of lamp string modules are electrically connected in series and said high-voltage circuit is connected to a first high-voltage connection end of a next lamp string module through said second high-voltage connection end.

18. The integrated series-connected lamp string according to claim 17, wherein said integrated series-connected lamp string comprises a bridge rectifier circuit and a filter module, wherein said bridge rectifier circuit is connected with said high-voltage circuit or said commercial power supply and said filter module is connected with said bridge rectifier circuit in series.

19. The integrated series-connected lamp string according to claim 18, wherein said transformer module is a high-frequency electronic transformer connected with said filter module and said transformer module transforms a voltage into said low-voltage circuit to supply power to said control module.

20. The integrated series-connected lamp string according to claim 19, wherein said control module is a single chip microcomputer, said light source is connected with said control module, and said low-voltage circuit supplies power to said light source after flowing through said control module.
